(19) United States
(12) Patent Application Publication
(10) Pub. No.: US 2008/0274041 A1
(43) Pub. Date: Nov. 6, 2008

(54) Preparation of nanoparticle-size zinc compounds

(75) Inventors: Mark D. Hughes, Montgomery, TX (US); Kenneth W. Koch, St. Louis, MO (US); Kenneth D. Miller, Conroe, TX (US); Daniel T. Smith, Montgomery, TX (US); Frederick F. Tripp, Montgomery, TX (US)

Correspondence Address: BURLESON COOKE L.L.P., 2040 NORTH LOOP 336 WEST, SUITE 123, CONROE, TX, 77304, US

(73) Assignee: Envirochem Solutions, L.L.C.

(21) Appl. No.: 11/800,084

(22) Filed: May 4, 2007

(51) Int. Cl. C01G 9/02; B01F 3/12

(52) U.S. Cl. 423/622; 516/9; 977/840

(57) ABSTRACT

A method for making a dispersion of zinc oxide particles in hydrocarbon is provided. A zinc compound that thermally disintegrates is dispersed in a hydrocarbon solvent with a selected organic acid and the mixture is heated to a temperature range to cause the zinc compound to thermally disintegrate into nano-sized particles.

### BACKGROUND

1. Field of the Disclosure

This disclosure relates to a method for making nanoparticle-size dispersions. More particularly, it relates to the preparation of nanoparticle-size zinc oxide dispersions in a hydrocarbon.

2. Description of Related Art

Zinc has been used for many years for a variety of purposes. For example, zinc is added to galvanized steel to protect against oxidation. Zinc is used as a catalyst in the vulcanization of rubber. Zinc compounds are also included in paints for metallic surfaces to provide cathodic protection.

In many applications, there are serious environmental and other concerns. For example, paint pigments containing zinc are typically ground to produce finer particles. However, these particles are still much larger than nano size. The larger particles require that larger amounts of paint be used to obtain adequate coverage. Reducing paint usage for a given application reduces volatile organic compounds (VOCs) emitted to the environment from paint solvents.

Zinc oxide is used in low concentrations in rubber formulations to improve vulcanization. Cadmium is a common contaminant in zinc oxide and is its presence in rubber used in tires causes environmental concerns. Wear of tires containing impure zinc can release cadmium into the environment. There is a need for zinc oxide for use in rubber that is free of cadmium.

Zinc oxide particles are typically produced through a very energy-intensive ball mill grinding process. The process can take many hours or even days to achieve particles in the low micron size range. Alternate production methods include energy-intensive gaseous reactions that require highly purified zinc as a starting material. Zinc oxide may also be produced as a by-product of steel production, but the quality of such product can be poor and environmentally harmful contaminants may be present.

There are other methods for producing small-particle zinc compounds (see, e.g., U.S. Pat. No. 6,503,475 and DE 199 07 704), but they typically require specialized equipment that is difficult and/or expensive to operate, adding to the cost of the finished product.

To avoid these high costs and/or contaminants, much zinc oxide comes from other sources that have even larger particle sizes. Such particles have a relatively small surface area to volume ratio, which is an important factor for many applications. This means that greater amounts of zinc must be used, which can increase the amount of contaminants included.

So-called “overbased” formulations made from magnesium and calcium compounds have been known for many years. Overbased means that there is greater than a stoichiometric amount of base material in a dispersion. These materials have demonstrated the advantages obtained by reducing the particle size of the materials. It is known to those skilled in the art of magnesium additives (see, e.g., U.S. Pat. Nos. 3,150,089 and 4,056,479) that overbased formulations having small particle sizes can perform at lower concentrations.

The formation, of magnesium oxide (MgO) through thermal degradation of magnesium hydroxide (Mg(OH)₂) is well known (e.g., Cheng et al., U.S. Pat. No. 4,163,728). During the Cheng process, Mg(OH)₂ is “explosively” degraded into MgO and H₂O to form an overbased dispersion of MgO. Magnesium carboxylates—i.e., magnesium salts of carboxylic acids—can also be used in similar fashion to produce MgO particles.

Because of the problems discussed above, there is a need for smaller-sized zinc compounds that contain fewer undesirable contaminants and that are produced at reasonable cost. What is needed is an economical method for making zinc oxide particles dispersed in a hydrocarbon and having dimensions less than about 100 nm.

### SUMMARY

The disclosed method includes dispersing a zinc oxide precursor into a mixture of hydrocarbon solvents and an organic acid. The mixture is heated to a selected temperature range. Water is distilled from the mixture. Solvent may also be distilled from the mixture, and may be refluxed during processing. The resulting mixture will contain a dispersion of zinc oxide particles in the nanoparticle size range.

### BRIEF DESCRIPTION OF THE DRAWINGS

FIG. 1 is a sketch of apparatus used for forming a dispersion of zinc oxide particles.

FIG. 2 is a graph showing the particle size distribution of a zinc oxide product made according to the disclosed method.

### DETAILED DESCRIPTION

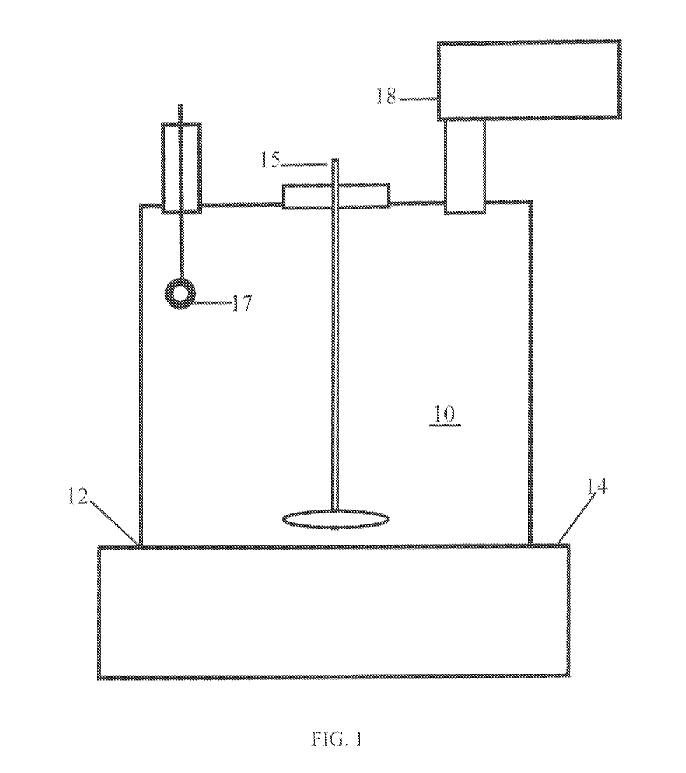

Referring to FIG. 1, hydrocarbon solvent is contained in reactor vessel 12 having heater 14. Stirrer 15 is used to maintain thorough mixing of liquid in the vessel. Temperature may be monitored with sensor 17. Overhead vapor from the vessel is condensed by condenser 18, which may be conventional apparatus known in the art.

Solvent 10, normally hydrocarbon, is placed in reactor vessel 12 along with an organic acid and a zinc compound. The solvent is normally a mixture of a high boiling point hydrocarbon (defined as a hydrocarbon solvent with a boiling point of at least 285° C.) and a low boiling point solvent, preferably an aromatic (defined as a hydrocarbon solvent with a boiling point below 285° C.). The low boiling point solvent(s), high boiling point solvent(s), and organic acid(s) are mixed. The low boiling point solvent is included to lower the viscosity of the mixture at lower temperatures to facilitate stirring and mixing. More specifically, the low boiling point solvent should have a boiling point between about 100° C. and about 285° C. and the high boiling point solvent should have a boiling point between about 285° C. and 400° C. The boiling points of the two solvents should be sufficiently different to allow the low boiling point solvent to completely boil off before a substantial amount of the high boiling point solvent is boiled off. The preferred low boiling point solvents are aromatics, but any organic solvent capable of reducing mixture viscosity at lower temperatures and being removed from the final product may be used. Preferably, the low viscosity solvent will be substantially removed by distillation at temperatures in the preferred operating range for the disclosed method, but solvents that require higher temperatures are included in the scope of the disclosed method. The choice of high boiling point solvent may depend in part on whether it is desirable to remove a significant amount of it from the final product. However, a high boiling point solvent that is prone to distilling off may be used when removal is undesirable by merely refluxing evaporated solvent to the reactor vessel.

The organic acid is preferably carboxylic or sulfonic acids or a mixture of carboxylic and sulfonic acids. These may be from a natural source or synthesized. The most preferred carboxylic acids are napthenic, oleic, and/or stearic acids or mixtures of acids, such as in tall oil fatty acid (“TOFA”). Alkoxy and phenoxy fatty acids, ether and thioether monocarboxylic acids, isopentanoic acid, 2-ethylhexoic acid, isooctanoic acid, isononanoic acid, and/or a neo acid (e.g., neodecanoic acid or natural or synthetic sulfonic acid) may also be used. The most preferred sulfonic acids are dodecylbenzene sulfonic acid (DDBSA), alkyl aryl sulfonic acid, monoalkylbenzenic and dialkylbenzenic acids, and combinations thereof, but many other sulfonic acids may be used in place of or in combination with these acids. The foregoing list is not meant to be exhaustive, but is provided for illustrative purposes only.

Normally, the final zinc compound is zinc oxide. The preferred zinc starting compound is zinc carbonate, which may contain significant amounts of Zn(OH)₂ (zinc hydroxide), but may be many other zinc compounds, including but not limited to zinc acetate dihydrate, zinc caprylate, zinc citrate dihydrate, zinc formate dihydrate, zinc laurate, zinc nitrate, zinc oleate, zinc oxide, zinc oxylate, zinc oxylate dihydrate, zinc peroxide, zinc stearate, and/or zinc hydroxy carbonate. The foregoing list is not meant to be exhaustive, but is provided for illustrative purposes only. The zinc precursor, preferably zinc carbonate, is added and dispersed throughout the liquid mixture, possibly after some initial heating of the liquid mixture. More generally, a suitable zinc source would be any of a group of compounds that could thermally decompose at a suitable temperature to effect a conversion of the starting material into another zinc material with “explosive fracturing,” or mechanical disintegration of the starting material.

It is believed that this decomposition results in the formation of zinc oxide. The final product is believed to be a zinc-acid soap that stabilizes the zinc oxide. In other words, it is a micelle of zinc oxide stabilized by the zinc soap. However, it is not necessary to the disclosed method that this belief be correct.

The dispersed solid comprises very small nanoparticles, typically with diameters from 10 to 350 nanometers, but especially between about 15 and about 150 nanometers. Preferably, a significant portion (e.g., more than half the volume) of the nanoparticles will have a diameter less than about 100 nm.

A metal to TOFA (Tall Oil Fatty Acid) ratio of about 2.6 to 1 has produced the best overall results for particle size and viscosity. (weight of zinc carbonate used:weight of TOFA used.) All dilutions may be done using paraffinic or naphthenic process oils to keep the aromatics out of the final product, which is desirable for applications in the rubber industry.

The disclosed process produces a class of compounds in overbased form with high stoichiometric ratios of transition metal to stabilizing carboxylic or sulfonic acid. By varying the formulation composition, the material may be produced as either a low-viscosity liquid, a high-viscosity liquid or a semisolid. This allows a potential user greater flexibility to provide more closely what is required in their marketplace or industry. This flexibility in composition is achieved by varying the ratio of zinc to blended carboxylic or sulfonic acids and by varying the type of acid. For example, if solid carboxylic acids—for example, stearic acid—are selected, products that are “greasy” semisolids can be produced. The term “semisolid” is used here to describe a material that does not readily flow, but readily yields to an object which is placed in it. Similarly, when a liquid blend of carboxylic acids—for example oleic acid—is selected, a liquid product can be produced. Blends of these example acids and/or others can produce products of intermediate properties.

The mixture is heated and the low boiling point solvent is allowed to boil off, keeping the pressure in the reactor vessel at atmospheric pressure. The low boiling point solvent is boiled off, typically by the time the batch temperature reaches 230° C. but this will depend on the choice of low boiling point solvent(s). Water should also begin boiling off by this time. This water may be formed by reactions in the mixture or may be present in the zinc precursor. Once all of the low boiling point solvent has been removed, the temperature is increased to about 350° C. and maintained in the 350-355° C. range. Some water will be produced at this time. Depending on the high boiling point solvent(s) chosen, some high boiling point solvent may boil off at this point. This may be refluxed back into the mixture, but it may or may not be necessary to do so. This temperature is preferably maintained as long as water is boiling off and may be maintained for about one hour or more after all water is removed. After this the heat source is removed and the mixture is allowed to cool. Some of the solvent may be added back into the mixture to speed cooling and dilute the final product as desired for a given application.

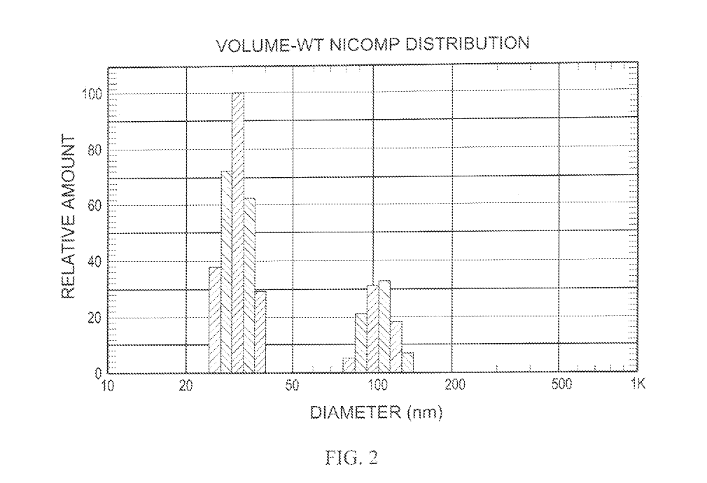

Zinc oxide prepared under the disclosed method may produce particles with a bimodal size distribution. Particle sizes of zinc oxide in solvent having a bimodal size distribution are illustrated in FIG. 2. This distribution may be favorable for some applications, where the smaller sized particles may provide benefits of high surface area while the larger sized particles—albeit still in the nanoparticle range—provide more reaction capacity.

The present method is capable of producing a product that is up to 40% zinc by weight. The zinc content is determined gravimetrically after other components are decomposed and volatilized. The higher concentration results in savings in transportation costs for the product.

The disclosed compound may be used in numerous applications. These applications include use in rubber manufacturing and/or processing for activation, acceleration, heat stabilization, light stabilization, tack retention, and metal bonding; in manufacturing polymers; in manufacturing ceramics; in pharmaceuticals; in lubricants; in paints; in cosmetics; in adhesives; in sealants; in photocopying; in lubricants; to remove sulfur from gases; in fire retardants; in fungicides; and as a cement additive. The foregoing list is not meant to be exhaustive, but is provided for illustrative purposes only. The choice of solvents and/or acids may be dictated by the intended application for the final product. For example, the use of TOFA as the sole acid is often preferred for products intended for use in manufacturing tire rubber, which often includes TOFA. The preferred ratio of Zn to TOFA is about 2.6 to 1, by weight, which was determined experimentally to produce the best results for small particle size and low viscosity. Other applications may work better with certain acids, solvents, or may function better with substantial amounts of acids and/or solvents removed during the heating process.

### EXAMPLES

The following examples are meant to illustrate the salient features of this process. They are not intended to limit the scope of the disclosure to only these chemistries and methods.

### Example 1

A reactor vessel was used to mix zinc carbonate powder, TOFA, high boiling point solvent (previously defined) and low boiling point solvent (previously defined). The reactor vessel was heated using well known procedures. The relative amounts of the ingredients were, by weight: 38.6% zinc carbonate, 14.8% TOFA, 25.0% process oil, and 21.6% low boiling point solvent. The liquids were added to the reactor and heated to 66° C. The zinc carbonate was added and thoroughly mixed into the liquid ingredients. The mixture was then heated to about 150° C. Some liquid began to distill off once the temperature reached 105° C. Once distillate was removed, the batch temperature was increased to about 260° C. Heating continued to remove all the low boiling point solvent, which was completed about the time the batch temperature reached approximately 270° C. Once the low boiling point solvent was completely removed, the batch temperature was increased to 350° C. By this time, substantially all water was removed. Batch temperature was maintained between 350° and 355° C. for one hour after the last of the water was removed. The heat source was then turned off and the mixture was diluted and cooled with 14.3% of the original process oil.

The above process produced an aromatic-free zinc product containing about 30% zinc by weight with particles in the nanoparticle range. The product was cadmium-free. The viscosity of the sample was checked with the Cannon-Fenske viscometer to be 167 cSt at 32° C. The product was filtered through a 200 micron filter without any sign of solids collecting.

During the processing about 11% of the charged process oil was removed to allow better temperature control of the batch. After processing the product was diluted and cooled with an additional 14.3% of the charged high boiling solvent.

A sample of the dispersion formed by the process described in this example was sent to Particle Sizing Systems of Santa Barbara, Calif. for measurement of particle sizes. Results of measurements (made by light scattering using a Nicomp Submicron Particle Size Analyzer) are shown in FIG. 2. Note the bimodal distribution of particle sizes. The mean diameter of the smaller particles, which consist of 75 percent of the total volume, was 31.6 nm. The mean diameter of the larger particles was 107.5 nm.

### Example 2

A suitably sized three neck reaction flask was fitted with a mechanical stirrer, a thermocouple thermometer, high temperature heating mantle, and a side-arm water distillation receiver set underneath a Freidrich's condenser. To the reaction flask was added by suitable methods: 120 grams of a low boiling point solvent, 110 grams of a high boiling point solvent, and 100 grams of a mixture of fatty acids (DT-22, one of many suitable low rosin formulations available from Arizona Chemicals). To this stirred solution was slowly added 260 grams of zinc carbonate, which was dispersed in the solvent.

The heating mantle was turned on and heat was continuously applied to first remove 120 grams of the low flash solvent—drained from the side-arm distillate receiver as needed. This required less than 2 hours and was completed by a temperature of 93° F. Heating was continued until approximately 229° C. was reached. This required approximately 1 hour. As heating was continued water began to distill into the side-arm distillate receiver, where it was drained from the receiver while allowing the solvent to freely return to the reaction flask. Some solvent was removed periodically. Continue to distill and drain water until about 32 grams have been removed. Heating was continued for another 1.5 hours until a temperature of 354° F. was reached. Water was removed from the side-arm receiver so it contains only the high boiling solvent and very little water. When the temperature reached 354° F., temperature was maintained for an additional 0.5 hours. After this period the reaction was considered to be complete and heating was discontinued.

The weight of high boiling solvent removed during processing was about 32 grams. When cooling was complete and the product removed from the reaction flask, there was approximately 334 grams of a 40.6% zinc material. The material was clear of particulate matter and relatively non-viscous.

### Example 3

A suitably sized three neck reaction flask was fitted with stirrer, thermometer, heating source, and condenser. To this was added 190 grams of a high boiling solvent and 185 grams of FA-1 TOFA. To this stirred solution was then slowly added 290 grams of zinc hydroxide, which was well dispersed. Heat was then applied to remove 27 grams of water that was formed during processing. When the temperature was raised only to 250° C. a hazy, viscous liquid product resulted. When cool, about 490 grams of the hazy material resulted. The zinc product contained only about 35.7% zinc as the metal.

### Example 4

A suitably sized three neck reaction flask was fitted with stirrer, thermometer, heating source, and condenser. To this was added 200 grams of a high boiling solvent, 200 grams of a low boiling solvent, and 185 grams of oleic acid. To this stirred solution was then slowly added 472 grams of zinc hydroxide, which was well dispersed. Heat was then applied to remove 200 grams of the low boiling solvent and any water that was formed during processing. The temperature was raised to about 400° C. When cool, about 775 grams of a clear, light colored, zinc compound resulted. The zinc product contained about 40% zinc as the metal.

### Example 5

A suitably sized three neck reaction flask was fitted with a stirrer, thermometer, heating source, and condenser. To this was added 200 grams of a high boiling solvent, 200 grams of a low boiling solvent, and 185 grams of a naphthenic acid. To this stirred solution was then slowly added 595 grams of zinc carbonate, which was well dispersed. Heat was then applied to remove 200 grams of the low boiling solvent and water that was formed during processing. The temperature was raised to about 400° C. When cool, about 775 grams of a clear, dark colored, zinc compound resulted. The zinc product contained about 40% zinc as the metal.

### Example 6

A suitably sized three neck reaction flask was fitted with stirrer, thermometer, heating source, and condenser. To this was added 200 grams of a high-boiling solvent, 200 grams of a low-boiling solvent and 370 grams of naphthenic acid. To this stirred solution was then slowly added 595 grams of zinc carbonate. The zinc carbonate was well dispersed. Heat was then applied to remove 200 grams of the low boiling solvent and any water that was formed during processing. The temperature was raised to about 400° C. While still warm the resulting flask contents were poured into a suitable container. When cool, about 960 grams of a clear, dark colored, zinc compound resulted. The zinc product contained about 32% zinc as the metal.

### Example 7

A suitably sized three neck reaction flask is fitted with stirrer, thermometer, heating source, and condenser. To this is added first 200 grams of a high boiling solvent, 200 grams of a low boiling solvent, and 185 grams of stearic acid. To this stirred solution is then slowly added 595 grams of zinc carbonate. The zinc carbonate is well dispersed. Heat is then applied to remove 200 grams of the low boiling solvent and any water formed during processing. The temperature is raised to about 400° C. While still warm the resulting flask contents are poured into a suitable container. When cool, about 775 grams of clear, light colored, semisolid zinc compound results. The zinc product contains about 40% zinc as the metal.

### Example 8

Example 3 is repeated using in place of oleic acid, 690 grams of stearic acid and 200 grams of an aromatic solvent. In this case, after stripping water and solvents, about 775 grams of a light colored, semisolid product results. The zinc product contains approximately 40% zinc as the metal.

Although the present disclosure has been described in detail, it should be understood that various changes, substitutions and alterations can be made thereto without departing from the scope and spirit of the invention as defined by the appended claims.

We claim:

1. A method for producing a dispersion of zinc oxide in hydrocarbon, the dispersion comprising particles having particle sizes less than 100 nm, comprising:
mixing a hydrocarbon solvent, an organic acid, and a zinc compound in a reactor vessel;
the zinc compound being selected to thermally disintegrate at a selected range of temperature; and
heating the mixture to at least the selected range of temperature and removing water to produce the dispersion.

2. The method of claim 1 wherein the hydrocarbon solvent is a mixture of two or more solvents having a higher and a lower range of boiling points.

3. The method of claim 2 wherein the solvent having the lower range of boiling point is aromatic.

4. The method of claim 1 wherein the organic acid is selected from organic acids consisting of oleic acid, stearic acid, tall oil fatty acids and naphthenic acid or mixtures thereof.

5. The method of claim 1 wherein the zinc compound is selected from zinc compounds consisting of zinc acetate dihydrate, zinc caprylate, zinc carbonate, zinc hydroxide, zinc citrate dihydrate, zinc formate dihydrate, zinc laurate, zinc nitrate, zinc oleate, zinc oxide, zinc oxylate, zinc oxylate dihydrate, zinc peroxide, zinc stearate, and zinc hydroxy carbonate.

6. The method of claim 1 wherein the zinc compound is zinc carbonate or a mixture of zinc carbonate and zinc hydroxide.

7. The method of claim 1 wherein the zinc compound is zinc hydroxide.

8. The method of claim 1 wherein the selected range of temperature is greater than about 250° C.

9. The method of claim 1 wherein the selected range of temperature is greater than about 350° C.

10. The method of claim 1 wherein the selected range of temperature is greater than about 400° C.

11. (canceled)

12. The method of claim 1 wherein the organic acid is a sulfonic acid or a mixture of carboxylic and sulfonic acids.

13. The method of claim 1 wherein the organic acid is selected from organic acids consisting of dodecylbenzene sulfonic acid (DDBSA), alkyl aryl sulfonic acid, monoalkylbenzenic acid, dialkylbenzenic acid, or mixtures thereof.

14. A dispersion of zinc oxide in a hydrocarbon, wherein the dispersion comprises particles having particle sizes less than 100 nm and wherein the dispersion is made by;
mixing a hydrocarbon solvent, an organic acid, and a zinc compound in a reactor vessel, the zinc compound being selected to thermally disintegrate at a selected range of temperature, heating the mixture to at least the selected range of temperature and removing water to produce the dispersion.

15. The dispersion of claim 14 wherein the organic acid is selected from organic acids consisting of oleic acid, stearic acid, tall oil fatty acids and naphthenic acid or mixtures thereof.

16. The dispersion of claim 14 wherein the zinc compound is selected from zinc compounds consisting of zinc acetate dihydrate, zinc caprylate, zinc carbonate, zinc hydroxide, zinc citrate dihydrate, zinc formate dihydrate, zinc laurate, zinc nitrate, zinc oleate, zinc oxide, zinc oxylate, zinc oxylate dihydrate, zinc peroxide, zinc stearate, and zinc hydroxy carbonate.

17. The dispersion of claim 14 wherein the organic acid is a sulfonic acid or a mixture of carboxylic and sulfonic acids.

18. The dispersion of claim 14 wherein the selected range of temperature is greater than about 250° C.

19. The dispersion of claim 14 wherein the selected range of temperature is greater than about 350° C.

20. The dispersion of claim 14 wherein the selected range of temperature is greater than about 400° C.
